(19) United States
(12) Patent Application Publication
(10) Pub. No.: US 2018/0291686 A1
(43) Pub. Date: Oct. 11, 2018

(54) Apparatus for mounting a ladder to a rotatable ladder base

(71) Applicant: Joseph J. Losito, Olathe, KS (US)

(72) Inventor: Joseph J. Losito, Olathe, KS (US)

(21) Appl. No.: 15/786,493

(22) Filed: Oct. 17, 2017

Related U.S. Application Data
(60) Provisional application No. 62/408,831, filed on Oct. 17, 2016.

(51) Int. Cl. E06C 7/42; E06C 5/36; E06C 7/50

(52) U.S. Cl. CPC E06C 7/42; E06C 7/50; E06C 5/36

(57) ABSTRACT

A mounting assembly for facilitating connection of ladder shoe-bearing ladder to a rotatable ladder base without creating two pivot points. The assembly is fixedly attached to a ladder shoe and is pivotably attached to a rotatable ladder base, but its rotatability, relative to the ladder base, is selectively disabled using an insertable retaining element.

This non-provisional application claims the benefit of provisional application No. 62/408,831 filed Oct. 17, 2016.

### BACKGROUND

The present invention generally relates to ladder bases used to support rigid ladders by way of inhibiting either their lower ends from sliding along the ground or toppling laterally while supporting users. It is more specifically directed to an assembly that enables such a ladder base—and, more particularly, one that is pivotally rotatable relative to the ladder it supports—to be quickly mounted to ladder shoes that are, themselves, pivotally attached to the lower ends. Moreover, it is directed to an assembly that enables such a mounting of pivotable ladder shoes to a rotatable ladder base accessory in a fashion which eliminates the dual pivotability that would otherwise be created and, instead, renders a safe attachment of the ladder to the ladder base.

As is familiar to those of ordinary skill in the art, the prior art is replete with base platform devices that are designed to provide stabilizing, non-slip support to the lower ends of rigid ladders while they are in use. Furthermore, because the angle of incidence between the ground and a ladder can vary as may be necessary, given the length of the ladder and the desired elevation of the ladder user, some such prior art ladder base devices attach to the lower ends of ladder rails and are configured so that their ground-engaging platform components may be rotated, to some extent, relative to the ladders they are mounted to.

For example, U.S. Pat. No. 9,359,820 to Markley, et al. discloses a ladder base device that can be pivoted, not simply to accommodate the appropriate ladder inclination angle, but to allow the platform to function as a completely reversible, dual-sided component. More specifically, Markley discloses a base platform having opposing surfaces of differing surface topographies (and/or surface materials) that are designed to provide non-slip engagement with completely different ground/floor surfaces, as well as a pair of socket-like receptacles into which the typical, rectangular cross-sectioned ends of a pair of ladder rails are to be plugged. Pivotal attachment of those rail receptacles to the base platform and the configuration of the base platform renders the platform 180 degrees rotatable relative to a mounted ladder. Thus, a user may selectively position either side of the base platform as its ground-engaging surface—a selection made based on the actual surface topographies of the platform sides and the character of the attendant ground surface.

However, as is widely understood, many contemporary, commercially available rigid ladders are sold with small, pivotable ground platforms, or “ladder shoes,” already fastened (typically, by bolt and nut) at each lower end of their rails. Like previously mentioned ladder base accessories, these ladder shoes are designed to prevent the ladder from sliding along the ground, and their pivotability accommodates a range of ladder inclination angles. Nevertheless, due to their typical sizes, ladder shoes generally do not provide any more lateral stability than a ladder would have without them. In contrast, the Markley non-slip base, for example, is specifically disclosed as having a platform piece that spans laterally beyond the ladder rails so that it inhibits a ladder from toppling laterally inasmuch as it inhibits a ladder from sliding. But, because the presence of a ladder shoe—which come in a variety of dimensions—gives a ladder rail end an irregular shape profile, ladder shoes would have to be removed from a ladder to enable the ladder rail ends to be inserted into the rectangular profiled rail receptacles employed by the Markley device. Moreover, the pivotability of ladder shoes would create two separate pivot points that would make a mounted ladder entirely unstable.

Consequently, it is appreciated that there is a need for an apparatus that enables a ladder, having hingedly attached ladder shoes, to be mounted to a pivotable ladder base without having to disassemble the ladder shoes to avoid creating two separate points of rotation. It can also be appreciated that there is a need for such an apparatus to accommodate ladders of different dimensions with respect to rail width and shoe size. The present invention substantially fulfills these needs.

### SUMMARY

It is an object of the present invention to provide an assembly that is useful for mounting, to a rigid ladder, an accessory ladder base which is designed to be rotatable relative to the mounted ladder. It is a further object for such an assembly to facilitate direct attachment to ladder shoes—which, themselves, are rotatable relative to the rails of the ladder—without creating multiple points of rotation. In one aspect of the invention, the present invention is both: (a) attachable to a ladder shoe in a way that does not interfere with the ladder shoe's range of motion relative to the ladder rail to which it is attached; and (b) attachable to a rotatable base plate accessory in a way that does prevent rotation of the base plate (by use of an insertable, rotation-preventing retaining pin).

Accordingly, it is another object of the invention to obviate the need to remove ladder shoes from a ladder as a prerequisite for attaching a rotatable base accessory to that ladder.

Finally, it is another object of the invention to allow a rotatable ladder base to be easily rotated (i.e., to have either of its opposing faces be selectively pivoted into ground-facing position) between uses without any tedious steps of disassembly or reassembly being required.

### BRIEF DESCRIPTION OF THE DRAWINGS

FIG. 1 is a top perspective view of a ladder base mounting assembly in accordance with the present disclosure, the assembly being shown in a disassembled state;

FIG. 2 is a top perspective view of the same, the assembly being shown in an assembled state;

FIG. 3 is as top plan view of the same, the assembly being shown attached to a rotatable ladder base; and

FIG. 4 is as bottom plan view of the same, the assembly being shown attached to a rotatable ladder base.

### DETAILED DESCRIPTION OF THE PREFERRED EMBODIMENTS

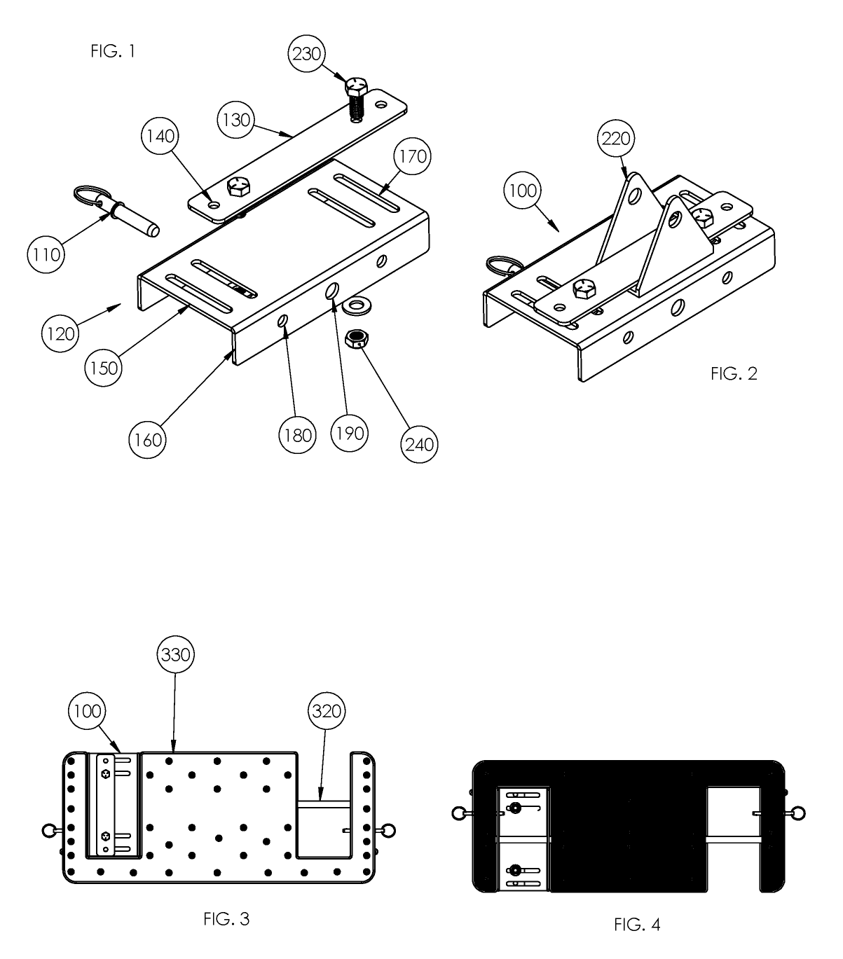

Referring now to FIGS. 1-4, there is illustrated a preferred embodiment of the ladder base mounting apparatus 100 of the present invention. The present assembly 100 allows a ladder base device 330, which provides lateral stability to, inhibits sliding along the ground by and is configured to be rotatable relative to the ladder it supports (not shown), to be securely attached to that ladder without requiring that ladder shoes 220—which are also rotatable relative to the ladder rails to which they are fastened—be removed from the ladder. It should be noted that a single unit of the mounting assembly 100 described herebelow and claimed herein is for attachment to a single ladder rail. So, in fact, two such assemblies (one dedicated to each of two ladder rails) are employed to fully mount a ladder to a ladder base 330.

The present assembly 100, shown in the accompanying drawings, comprises two main components: a frame 120 and fastening element 130. The frame 120 is comprised of two, laterally-spaced vertical supports 160, as well as a horizontal support surface 150 that spans between their respective upper ends to give the frame 120 a gantry-like configuration. The fastening element 130 can take on a variety of different forms (e.g., rigid plate, strap, etc.) which are capable of being fastened to the support surface 150. Nevertheless, in a preferred embodiment, it is an elongate, rigid plate—a planar surface capable of stably resting along the top face of the ground support surface of a ladder shoe, and it has, formed within it, at least one pair of longitudinally spaced circular holes 140 through which fasteners (e.g., bolts) can be inserted. The frame support surface 150, preferably, has multiple pairs of holes 170 formed within it. Each such pair is in longitudinally-spaced alignment with the fastener receiving holes 140 residing in the fastening plate 130, but these holes 170 should be laterally elongate, not circular, to account for a range of different lateral spacing that exists between the rails of different ladders. Finally, axially-aligned pivot rod receiving holes 190 are formed in both vertical supports 160, and a retainer hole 180 is formed in the laterally outer support 160.

The present mounting assembly 100 is attached to the ladder shoe-bearing lower end of a ladder rail by directly fastening it to the ladder shoe 220. More specifically, the bottom face of the ground support surface of the ladder shoe 220 is laid flat atop the horizontal frame support surface 150, and the elongate fastener plate 130 is, then, laid flat onto the top face of the ladder shoe surface such that that plate 130 extends longitudinally beyond both longitudinal ends of the shoe. Then, with the ladder shoe sandwiched between the fastener plate 130 and frame support surface 150, the fastener plate 130 is securely coupled to the gantry-like frame 120. That secure coupling can be accomplished in various ways that may represent varying degrees of permanence, but in a preferred embodiment, a bolt (or screw) 230 is inserted down through the aligned holes 140, 170 in the fastener plate 130 and frame support surface 150, respectively, and a nut 240 is tightly threaded onto the bolt 230. Of course, the exact positioning of the bolt along the lateral length of the fastener receiving hole 170 in the frame support surface 150 is dictated by the lateral spacing of this ladder shoe from the opposing ladder shoe (which will also have a mounting assembly 100 attached to it).

One can safely assume that the pivotable ladder base device to which the present mounting assembly 100 is to be attached is pivotable specifically because it possesses a rotating cylinder, or pivot rod, that extends laterally through the platform and is intended to have a ladder somehow directly attached to it (as opposed to being directly attached to the base platform component). For example, the ladder base 330 illustrated in FIGS. 3 & 4 features such a pivot rod 320. To install the present assembly 100, that rod 320 should be removed from the base 330 and the mounting assembly 100 should be positioned in the space where the ladder ends (or a ladder end receptor that is part of the ladder base assembly 330) would occupy. Then, the base's pivot rod 320 should be inserted through both the appropriate bore(s) in the base 330 and the receiving holes 190 in the vertical support portions 160 of the gantry-like frame 120. Finally, to prevent the coupled mounting assembly 100 and ladder base 330 from rotating relative to each other, a retaining element (preferably, a cylindrical pin) 110 is inserted through an appropriate bore in the outer portion of the base 330 and the retainer hole 180 formed in the frame vertical support 160. When so inserted, the ladder base 330 remains able to pivot, relative to the ladder, due to the ladder shoe 220 continuing to enjoy its full range of rotation relative to the ladder rail.

Aspects of various embodiments of the present invention that are not recited above or claimed below may be noted from observing the illustrations included herein.

What is claimed is:

1. A mounting apparatus configured to pivotally mount the rail of a ladder, having a ladder shoe pivotally attached thereto, to a ladder base device that is, itself, configured to inhibit a ladder from sliding along the ground or toppling laterally, the apparatus comprising:
a gantry-like frame, having a pair of laterally-spaced vertical supports extending downward from a horizontal support surface, wherein the support surface is configured to have the ground support surface of the ladder shoe placed thereatop for stable attachment thereto;
a fastening element configured to be disposed over the ground support surface of the ladder shoe and to couple together the ladder shoe and the frame; and
wherein the frame is pivotally attachable to the ladder base device.

2. The mounting apparatus of claim 1, wherein said fastening element couples together the ladder shoe and said frame by said fastening element being disposed over said frame support surface, with the ground support surface of the ladder shoe being sandwiched therebetween, and said fastening element being fastened to said frame.

3. The mounting apparatus of claim 1, wherein pairs of longitudinally-spaced fastener receiving apertures reside in said fastening element and said frame support surface, respectively, and wherein these respective pairs of apertures are longitudinally aligned.

4. The mounting apparatus of claim 3, wherein said mounting apparatus further comprises a pair of fasteners which are each configured to be protruded through the fastener receiving apertures in both said fastening element and said frame support surface and secured to said fastening element and said frame support surface.

5. The mounting apparatus of claim 3, wherein at least one of said fasteners is a bolt and nut combination.

6. The mounting apparatus of claim 6, further comprising a retaining element configured to inhibit said frame from pivoting, relative to the ladder base device to which said frame is pivotally attached, while not inhibiting the ladder rail from pivoting relative to the ladder base device.

7. The mounting apparatus of claim 1, wherein a retainer receiving aperture resides in a vertical support.

8. The mounting apparatus of claim 7, wherein said frame is inhibited from pivoting, relative to the ladder base device to which it is pivotally attached, by inserting a retaining element laterally through both the ladder base and the retainer receiving aperture, but wherein the ladder rail remains pivotable relative to the ladder base device.

9. The mounting apparatus of claim 8, wherein said retaining element is a pin.

10. A ladder base device configured to pivotally mount to the rails of a ladder, having ladder shoes pivotally attached thereto, and configured to inhibit the ladder from sliding along the ground or toppling laterally, the ladder base device comprising:
a slip-inhibiting platform, wherein the platform has opposing surfaces configured for engagement with floor or ground surfaces;
a pair of gantry-like frames, wherein each such frame has a pair of laterally-spaced vertical supports extending downward from a horizontal support surface, wherein the horizontal support surface is configured to have the ground support surface of a ladder shoe placed thereatop for stable attachment thereto;
a pair of fastening elements, wherein each such fastening element is configured to be disposed over the ground support surface of a ladder shoe and to couple together that ladder shoe and a frame; and
wherein each frame is pivotally attachable to the slip-inhibiting platform.

11. The ladder base device of claim 10, wherein said frames are inhibited from pivoting, relative to said platform to which the are pivotally attached, by inserting a retaining element laterally through both said platform and at least one of said frames, but wherein the ladder rails remain pivotable relative to said platform.
